(19) United States
(12) Patent Application Publication
(10) Pub. No.: US 2005/0255883 A1
(43) Pub. Date: Nov. 17, 2005

(54) Headset eyewear

(76) Inventor: Bruce Hood, Huntington Beach, CA (US)

Correspondence Address: John H. Lynn, Suite C 103, 2915 Redhill Ave., Costa Mesa, CA, 92626, US

(21) Appl. No.: 11/104,719

(22) Filed: Apr. 12, 2005

Related U.S. Application Data
(60) Provisional application No. 60/565,167, filed on Apr. 23, 2004.

(51) Int. Cl. H04M 1/00

(52) U.S. Cl. 455/556.1

(57) ABSTRACT

A combined telephone headset and eyewear device includes a pair of eyeglasses having an integral telephone headset. A speaker support rod has a first end pivotally mounted in the slot in one of the temple bars and a second end having a telephone speaking device connected thereto. The speaker support rod may be rotated between a deployed position in which its second end is near the user's mouth and a retracted position in which it is retained within the slot. An earphone assembly includes an earphone support rod having a first end pivotally mounted in the slot in the temple bar portion and a second end arranged to have an earphone connected thereto. The earphone support rod may be rotated about its first end between a deployed position in which its second end is near the user's ear and a retracted position in which it is retained within the slot.

### CROSS REFERENCE TO RELATED APPLICATION

Applicant claims priority based upon his Provisional Application Ser. No. 60/565,167, filed in the U.S. Patent and Trademark Office on Apr. 23, 2004.

### BACKGROUND OF THE INVENTION

This invention is directed to eyewear having a cell phone head set integrated into the temple bars of a pair of eyeglasses.

As cell telephone usage increases there is a need for hands-free operation without resorting to the well-known headset and speaker combination.

### SUMMARY OF THE INVENTION

Headset eyewear according to the present invention combines stylish eyewear with an integrated cell phone head set designed for use while driving, walking or in recreational activities such as golf or poolside lounging or sunbathing. Headset eyewear according to the invention is much more comfortable to use than ordinary one-sided headsets that hang off one ear because the weight is more evenly distributed around the user's face. This invention eliminates the choice between protecting one's eyes from the sun's harmful rays and speaking comfortably hands-free while on the go. With retractable mouth and earpieces the user will look great all the time whether on the phone or not in both indoors and outdoors activities.

The advantages and structural features of the invention may be understood and appreciated by referring to the accompanying drawings (not to scale) and the following detailed description of the invention.

### BRIEF DESCRIPTION OF THE DRAWINGS

FIG. 1 is a perspective view of headset eyewear according to the invention.

FIG. 2 is a perspective view with a portion of a temple bar being cut away to show a telephone speaker and an earphone installed inside the temple bar.

FIG. 3 shows the telephone speaker and earphone in a deployed position for use in making or receiving a telephone call.

FIG. 4 is a perspective view showing the invention mounted on a user's head.

FIG. 5 is a side elevation view of a temple bar showing the speaker and earphone retracted in a slot inside the temple bar.

FIG. 6 is a side elevation view showing the speaker and earphone rotated out of slot for use in making or receiving a telephone call.

FIG. 7 is a bottom plan view of the temple bar showing the speaker and earphone retracted into the slot in the temple bar.

### DETAILED DESCRIPTION OF THE INVENTION

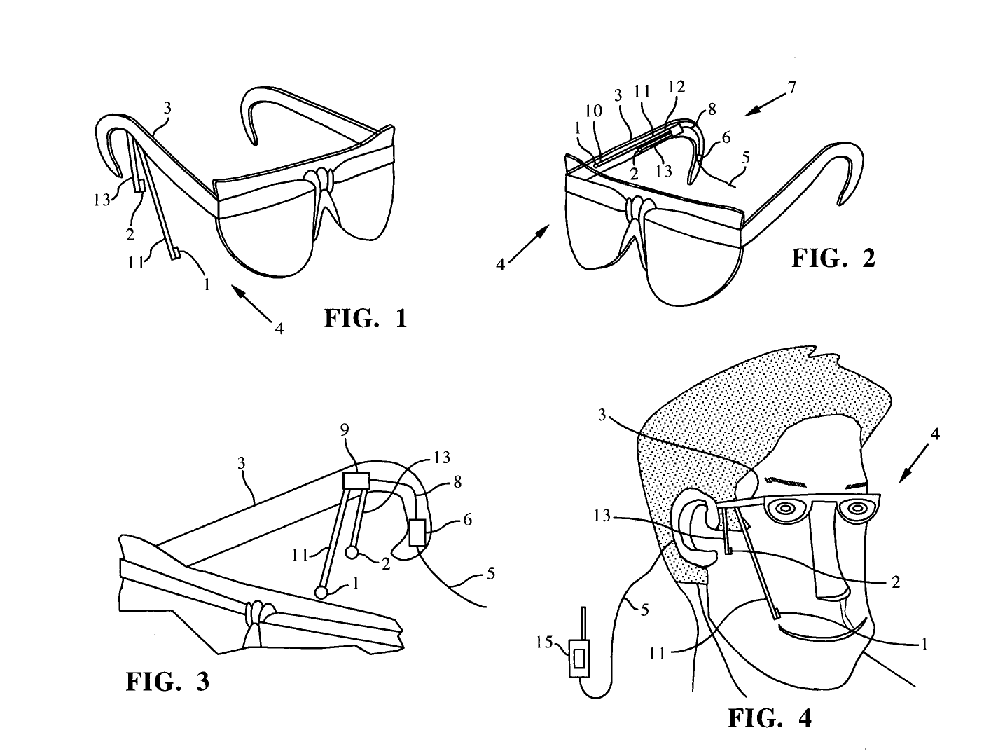

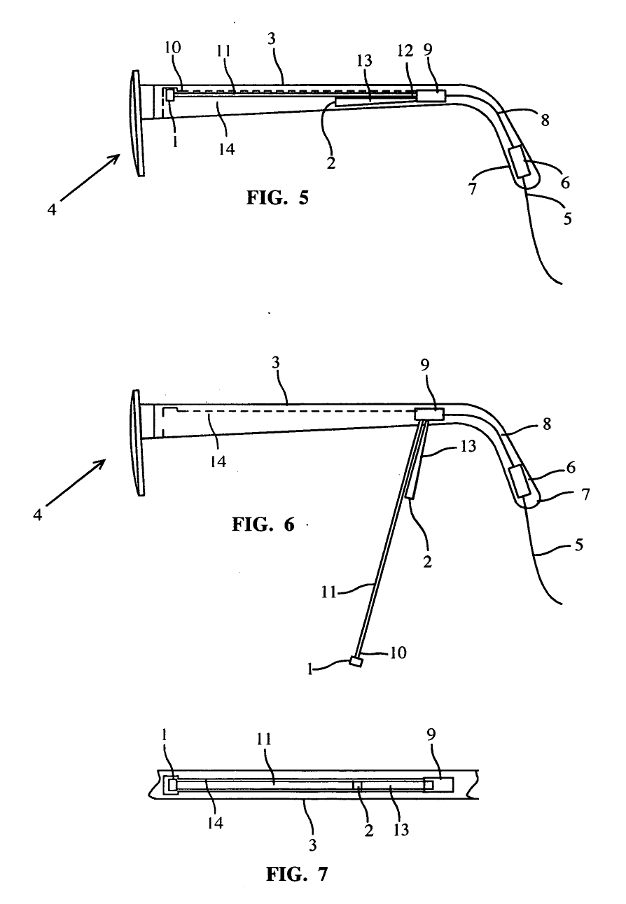

Referring to FIG. 1, this invention includes a telephone speaking device 1 and an earphone 2 that descend from a temple bar 3 of a pair of eyeglasses 4. As shown in FIGS. 2 and 5, the speaker 1 and earphone 2 are retractable into the temple bar 3.

Referring to FIG. 4, a telephone 15 may be secured to the user's belt or placed in a pocket, a purse etc. A wire 5 may extend from the telephone to a connecter 6 mounted in an outer end portion 7 of the temple bar 3 to transmit signals between the telephone and the speaking device 1 and the telephone and the earphone 2. Such signal transmission may also be accomplished using electromagnetic radiation as exemplified by Bluetooth technology.

As shown in FIGS. 2-6, a wire 8 extends from the connector 6 to a mounting bracket 9 that is embedded in the temple bar 3. The speaker 1 is mounted to an end 10 of a speaker support rod 11 that has an end 12 pivotally mounted to the mounting bracket 9. The earphone 2 is mounted to an earphone support rod 13 that is also pivotally connected to the bracket 9.

A slot 14 extends from the bracket 9 lengthwise in the temple bar 3 to accommodate the speaker 1, the speaker support rod 11, the earphone 2 and the earphone support rod 13 so that these components may be concealed from view when not in use.

As shown in FIGS. 2 and 6, the speaker support rod 11 and the earphone support rod 13 may be rotated out of the slot 14 when the user desires to have a telephone conversation.

FIG. 7 shows the speaker 1, the speaker support rod 11 and the earphone 2 retracted into the slot 14. When the speaker 1, the speaker support rod 11 and the
earphone 2 are not deployed for use, they may be retained in the slot 14 by friction or a snap fitting that may be manually disengaged.

1. A combined telephone headset and eyewear device designed for mounting to a user's head, comprising:
a frame that includes a lens holder portion arranged to hold a lens spaced apart from the user's face and a temple bar portion having a first end mounted to an end portion of the lens holder portion and a second end portion that extends away from the lens holder portion to a location near an ear of the user, the temple bar portion including a lengthwise slot therein;
a speaker support rod having a first end that is pivotally mounted in the slot and a second end that is arranged to have a telephone speaking device connected thereto, the speaker support rod being arranged to be rotated between a deployed position in which its second end is near the user's mouth and a retracted position in which it is retained within the slot; and
an earphone assembly that includes an earphone support rod having a first end that is pivotally mounted in the slot in the temple bar portion and a second end arranged to have an earphone connected thereto, the earphone support rod being arranged to be rotated about its first end between a deployed position in which its second end is near the user's ear and a retracted position in which it is retained within the slot.

2. The combined telephone headset and eyewear device of claim 1, further comprising a mounting bracket mounted within the slot wherein the speaker support rod and the earphone support rod are pivotally mounted to the mounting bracket.
